(19) United States
(12) Patent Application Publication
(10) Pub. No.: US 2012/0000439 A1
(43) Pub. Date: Jan. 5, 2012

(54) Piston for an internal combustion engine

(75) Inventors: Rainer Scharp, Vaihingen (DE); Sascha-Oliver Boczek, Dielheim (DE)

(73) Assignee: MAHLE International GmbH, Stuttgart (DE)

(21) Appl. No.: 13/135,134

(22) Filed: Jun. 27, 2011

(30) Foreign Application Priority Data
Jun. 29, 2010 (DE) 10 2010 025 508.4

(51) Int. Cl. F02F 3/16

(52) U.S. Cl. 123/193.6

(57) ABSTRACT

A piston for an internal combustion engine has an upper and a lower piston part. The upper piston part has a cooling cavity on its underside, and the lower piston part has a ceiling element with a cover hood, which closes off the cooling cavity. The cover hood is securely attached on the ceiling element if the central part of the cover element has an oil drain opening, the top of which is formed as a neck, the upper edge of which neck has a circumferential bead having an underside configured as a circumferential undercut, and if the cover hood has a centrally located opening, the edge of which has slits that are distributed over the circumference and lie radially. The cover hood is attached on the neck so that the sheet-metal tabs are snapped in below the undercut, between the slits, and form a secure snap-in connection with the neck.

### CROSS REFERENCE TO RELATED APPLICATIONS

Applicants claim priority under 35 U.S.C. §119 of German Application No. 10 2010 025 508.4 filed on Jun. 29, 2010, the disclosure of which is incorporated by reference.

### BACKGROUND OF THE INVENTION

1. Field of the Invention

The invention relates to a piston for an internal combustion engine, which consists of an upper piston part connected with a lower piston part. The upper piston part has a piston crown and a cooling cavity that is open toward the bottom and lies centrally on the underside, facing away from the piston crown, and the lower piston part has a ceiling element, by way of which the lower piston part is connected with the upper piston part. Skirt elements and pin bosses are formed onto the underside of the ceiling element, and a centrally located cover hood is attached to the ceiling element, the outside diameter of which hood corresponds at least approximately to the diameter of the cooling cavity, and which hood closes off the cooling cavity in a downward direction.

2. The Prior Art

A piston of the type stated above is known from the unexamined published patent application DE 198 46 152, in which a cover hood consisting of a resilient metal sheet forms the lower delimitation of an inner cooling cavity. In this connection, the cover hood is fixed in place in the region of the pin boss support, under spring stress, and is attached in the piston interior by way of an engagement connection. In this connection, the edge of the cover hood merely has a half-round brim, in cross-section, which brim engages into a circumferential recess, also having a half-round cross-section, during attachment of the cover hood. It is disadvantageous, in this connection, that the engagement connection that results from this already comes loose at even slight stress that acts on the cover hood by the cooling oil situated in the cooling cavity, and this can lead to damage to the engine during engine operation.

### SUMMARY OF THE INVENTION

It is therefore an object of the present invention to avoid this disadvantage of the state of the art and to guarantee a reliable connection between the cover hood that serves to close off the cooling cavity and the piston interior.

This task is accomplished in that the central part of the cover element is configured as a dome that is directed upward, and has two openings that lie opposite one another, between which openings a centrally located oil drain opening is disposed, the top of which is formed as a neck, the upper edge of which neck has a circumferential bead that is directed radially outward. The underside of the bead is configured as a circumferential undercut, radially on the outside, and the cover hood is configured in the manner of a dome and has a centrally located opening. The inside diameter of the opening corresponds to the outside diameter of the neck, and the edge of the opening has slits that are distributed over the circumference and lie radially, between which slits the edge region of the opening is configured in the form of elastically resilient sheet-metal tabs. The cover hood is attached on the neck, by way of its opening, in such a manner that the sheet-metal tabs are snapped in below the undercut, and form a secure snap-in connection with the neck.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a piston for an internal combustion engine, having a cover hood according to the invention, for closing off a cooling cavity that lies centrally,

FIG. 2 shows an enlarged representation of the region A from FIG. 1,

FIG. 3 shows an enlarged representation of the region B from FIG. 2,

FIG. 4 shows an enlarged representation of the region C from FIG. 1,

FIG. 5 shows a sectional representation of the piston along the line V-V in FIG. 1, with the viewing direction toward the underside of the piston,

FIG. 6 shows a section through the cover hood along the line VI-VI in FIG. 7,

FIG. 7 shows a top view of the cover hood, and

FIG. 8 shows a perspective representation of the cover hood.

### DETAILED DESCRIPTION OF THE PREFERRED EMBODIMENT

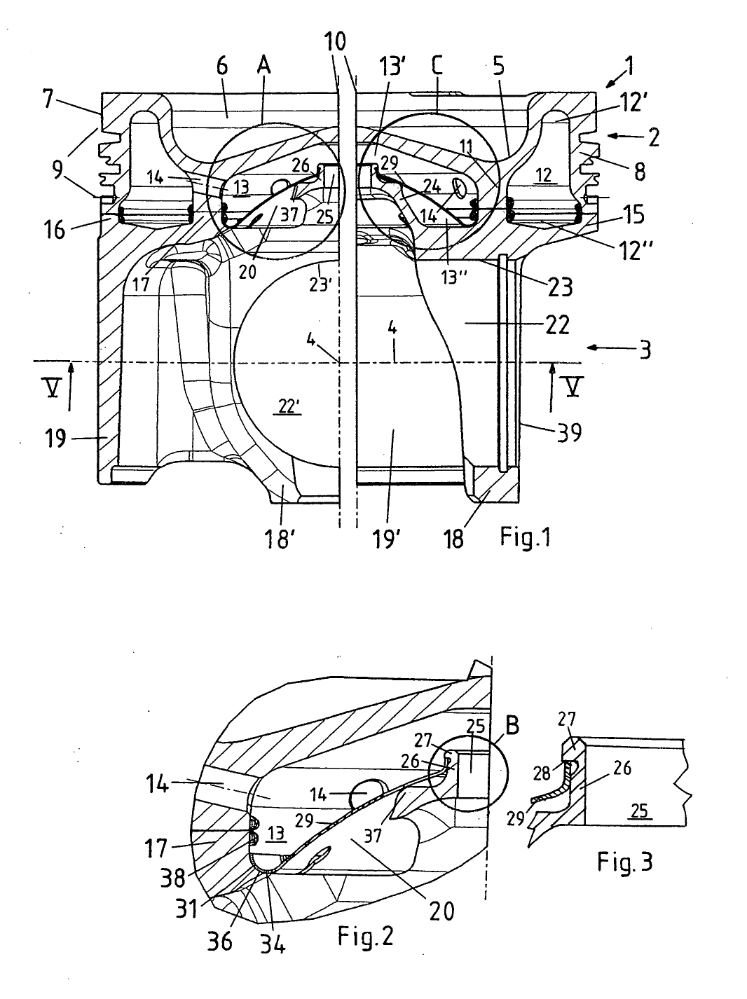

Referring now in detail to the drawings, FIG. 1 shows a piston 1 for a diesel engine, which consists of an upper piston part 2 and a lower piston part 3. Piston 1 is shown in a two-part sectional representation, whereby the section plane of the left half of the sectional representation lies perpendicular to piston bore axis 4, while the section plane of the right half of the sectional representation lies on piston bore axis 4. In the following description of piston 1, “top” means the side facing the piston crown, and “bottom” means the side of piston 1 facing away from the piston crown.

Piston 1 has a combustion chamber bowl 6 formed into piston crown 5. Radially on the outside, piston crown 5 is followed by a top land 7 and a ring wall 8 having a ring belt 9. Ring wall 8 and piston crown 5 are parts of the upper piston part 2, which has a circumferential ring rib 11 formed onto the underside of piston crown 5, radially on the inside between ring wall 8 and piston axis 10.

Upper region 12′ of a cooling channel 12 that runs radially on the outside is delimited by ring wall 8, by piston crown 5, and by ring rib 11. Furthermore, piston crown 5 and ring rib 11 delimit the upper region 13′ of a centrally disposed cooling cavity 13. Overflow channels 14 are worked into ring rib 11, between cooling cavity 13 and cooling channel 12, distributed over the circumference.

Lower piston part 3 has an upper ceiling element 15, into the top of which a circumferential recess is formed, radially on the outside, which recess forms lower region 12″ of the cooling channel 12. Radially on the outside, region 12″ is delimited by a circumferential formed-on part 16 that is directed upward, whereby support surface 17 forms the radially outer delimitation of lower region 13″ of centrally located cooling cavity 13, which region is formed into the top of ceiling element 15. When upper piston part 2 and lower piston part 3 are connected with one another, regions 12′ and 12″ form cooling channel 12, and regions 13′ and 13″ form cooling cavity 13.

Two pin bosses 18, 18′ that lie opposite one another, each having a pin bore 22, 22′, are formed onto the underside of ceiling element 15, which pin bosses are connected with one another by way of two skirt elements 19, 19′ that lie opposite one another and are also formed onto the underside of ceiling element 15. The radially outer face sides 39 of pin bosses 18 are set back with regard to the radial outside of ring wall 8, in the direction of piston axis 10.

Piston 1 consists of steel and is preferably used for diesel engines of commercial vehicles. However, piston 1 according to the invention can also be used in diesel engines of passenger cars. Within the scope of the production of piston 1, blanks of upper piston part 2 and of lower piston part 3 are first produced using a forging or casting method, and afterwards, two parts 2 and 3 are finished on a lathe. Subsequently, the two parts 2 and 3 are connected with one another by friction welding, whereby upper piston part 2 and the lower piston part 3 are put into rotational motion relative to one another in a suitable holding device, and, at the same time, are pressed onto one another with great force, by way of the faces sides of ring wall 8 that lie opposite one another and formed-on part 16, and by way of the face sides of the ring rib 11 that lie opposite one another and support surface 17. As a result, the piston material is welded together in the region of the face sides of ring wall 8, formed-on part 16, ring rib 11, and support surface 17.

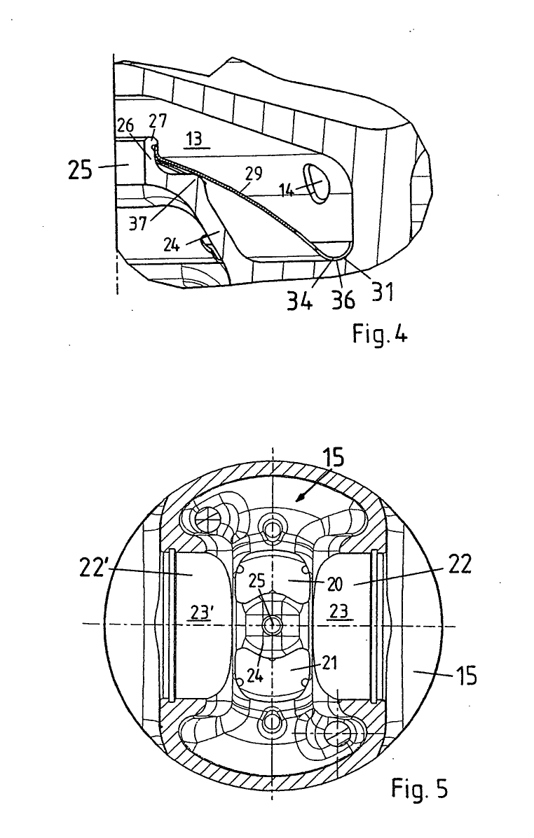

The central part of ceiling element 15, which forms the lower delimitation of centrally located cooling cavity 13, has two openings 20, 21 that lie opposite one another, as FIG. 5, a sectional representation of piston 1 along the line V-V in FIG. 1, with a view from below of ceiling element 15, particularly shows. FIG. 5 furthermore shows a view from below of zeniths 23. 23′ of each of the pin bores 22, 22′. A crosspiece 24 is formed between zeniths 23, 23′ of pin bores 22, 22′, by means of openings 20 and 21 in ceiling element 15, which crosspiece has a centrally located oil drain opening 25. (See, in this regard, FIGS. 1 and 4.) The purpose of this crosspiece construction 24 consists in reducing the weight of piston 1.

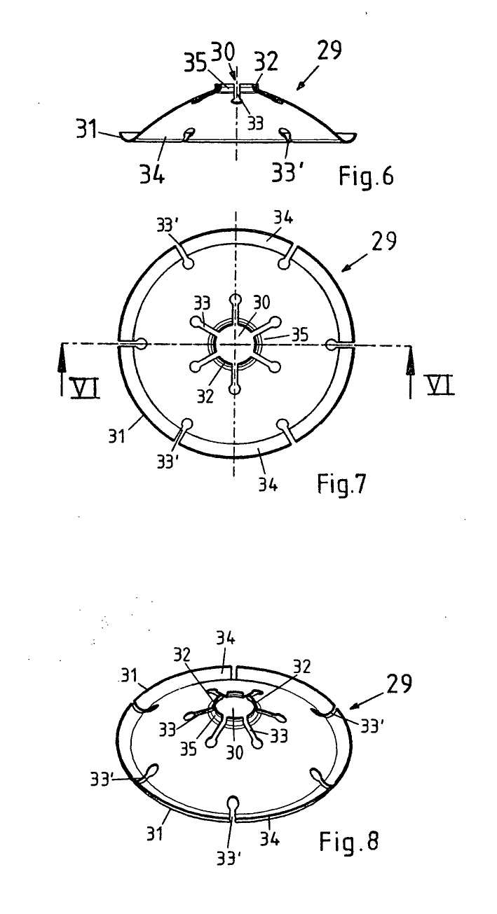

In order to close off cooling cavity 13, which lies centrally, the top of oil drain opening 25 is configured as a neck 26, as can be seen particularly well in FIG. 2 (an enlarged representation of the region A from FIG. 1), FIG. 3 (an enlarged representation of the region B from FIG. 2), and FIG. 4 (an enlarged representation of the region C from FIG. 1). The upper edge of neck 26 has a circumferential bead 27 that is directed radially outward, and the underside of bead 27 is configured as a circumferential undercut 28 radially on the outside, as FIG. 3, which is an enlarged representation of the region B in FIG. 2, clearly shows. This undercut 28 serves to fix a cover hood 29, which is shaped in dome-like manner, as shown in FIGS. 6 to 8, in place by way of a snap-in connection.

This cover hood 29 serves, as FIG. 1 shows, to close off the centrally located cooling cavity 13 in a downward direction, in order to improve the cooling effect of the cooling oil contained in cooling cavity 13 during engine operation. Oil is catapulted back and forth between cover hood 29 and piston crown 5, and thereby extracts heat from piston crown 5, particularly in the region of combustion chamber bowl 6 (Shaker effect).

As FIGS. 6 to 8 show, the cover hood 29 has a centrally located opening 30, whereby both the radially outer edge 31 of the cover hood 29 of the and edge 32 of the opening 30 have slits 33, 33′ that are distributed over the circumference and lie radially, the length of which slits corresponds approximately to one-fifth of the distance between radially outer edge 31 of cover hood 29 and edge 32 of central opening 30. In the present embodiment, six slits 33, 33′ are introduced into each of edges 31 and 32. It is also possible to form more or fewer than six slits 33, 33′ into the edges 31, 32. In every case, however, attention must be paid to ensure that two slits 33, 33′ are not disposed one behind the other, seen in the radial direction, in other words that the slits 33 and 33′ are disposed offset from one another, seen in the radial direction. If the slits were disposed one behind the other, seen in the radial direction, regions having reduced material would be created between them, thereby reducing the spring force of the cover hood 29 in these regions, and this would reduce the strength of the seating of cover hood 29.

These slits 33, 33′ delimit sheet-metal tabs 34 and 35 that are distributed over the circumference of edges 31 and 32, whereby the sheet-metal tabs 34, 35 are elastically resilient, because of slits 33, 33′. This allows easy and quick installation of cover hood 29, which is pushed over neck 26 of oil drain opening 25 with its centrally located opening 30 after upper piston part 2 and lower piston part 3 have been finished by lathing, but before these parts 2 and 3 are welded to one another. The sheet-metal tabs 35 of opening 30 give way in a resilient manner when they are pushed over bead 27 of the neck 26, in order to then snap into undercut 28 of the bead 27 when they have been pushed down far enough, thereby causing cover hood 29 to be fixed in place on the ceiling element 15, where it remains unreleasably attached even during faster back and forth movements of piston 1 during engine operation.

In this connection, outer edge 31 of cover hood 29, as FIGS. 2 and 4 clearly show, is pressed into the lower, radially outer region 36 of cooling cavity 13, whereby the sheet-metal tabs 34 that lie radially on the outside give way elastically and ensure a secure hold of cover hood 29. If edge 31 of cover hood 29 comes to lie under the lower, inner weld bead 38 in the region of support surface 17, so that edge 31 thereby comes to lie against weld bead 38, this results in further improvement of the security of the hold of cover hood 29. (See FIG. 2 in this regard.)

Because cover hood 29 furthermore lies on a ring-shaped formed-on part 37, which is step-shaped in cross-section and is spaced apart from bead 27 of neck 26, in the outer region of the neck 26, a bias is produced in cover hood 29, which contributes to the strength of the installation of cover hood 29.

The configuration of cover hood 29 according to the invention has the advantage that it can be installed easily and quickly, thereby reducing the production costs of the piston, although it is nevertheless securely fixed in place, particularly during engine operation at very fast back and forth movements of piston 1. Furthermore, neck 26 of the oil drain opening 25 is structured to have rotation symmetry with bead 27 and the undercut 28, so that it can easily and quickly be produced on a lathe, thereby contributing to a further reduction in the production costs of the piston.

Accordingly, while only a few embodiments of the present invention have been shown and described, it is obvious that many changes and modifications may be made thereunto without departing from the spirit and scope of the invention.

### REFERENCE SYMBOL LIST

A, B, C region
1 piston
2 upper piston part
3 lower piston part
4 piston bore axis
5 piston crown
6 combustion chamber bowl
7 top land
8 ring wall
9 ring belt
10 piston axis
11 ring rib
12, 12′, 12″ cooling channel
13, 13′, 13″ cooling cavity
14 overflow channel
15 ceiling element of the lower piston part 3
16 formed-on part
17 support surface
18, 18′ pin boss
19, 19′ skirt element
20, 21 opening of the ceiling element 15
22, 22′ pin bore
23, 23′ zenith of the pin bore 22
24 crosspiece
25 oil drain opening
26 neck
27 bead
28 undercut
29 cover hood
30 opening
31 outer edge (region) of the cover hood 29
32 edge (region) of the opening 30
33, 33′ slits in the edges 31 and 32
34, 35 sheet-metal tabs
36 region of the cooling cavity 13
37 formed-on part
38 welded bead in the region of the support surface 17
39 face side of the pin bosses 18

What is claimed is:

1. A piston for an internal combustion engine, comprising:
an upper piston part having a piston crown and a cooling cavity that is open toward a bottom and lies centrally on an underside, facing away from the piston crown;
a lower piston part having a ceiling element that connects the lower piston part with the upper piston part;
skirt elements and pin bosses formed onto an underside of the ceiling element; and
a centrally located cover hood attached to the ceiling element, said cover hood having an outside diameter that corresponds at least approximately to a diameter of the cooling cavity, and which hood closes off the cooling cavity in a downward direction,
wherein a central part of the ceiling element is configured as a dome that is directed upward, and has two openings that lie opposite one another, between which openings a centrally located oil drain bore is disposed, a top of said bore being formed as a neck, an upper edge of said neck having a circumferential bead that is directed radially outward, wherein an underside of the bead is configured as a circumferential undercut, radially on an outside,
wherein the cover hood is configured as a dome and has a centrally located opening,
wherein an inside diameter of the centrally located opening corresponds to an outside diameter of the neck,
wherein an edge of the centrally located opening has slits that are distributed over the circumference and lie radially, between which slits an edge region of the centrally located opening is configured in the form of elastically resilient sheet-metal tabs,
wherein the cover hood is attached on the neck, by way of the centrally located opening, in such a manner that the sheet-metal tabs are snapped in below the undercut, and form a secure snap-in connection with the neck, and
wherein the radially outer edge of the cover hood lies against the top of the ceiling element.

2. The piston according to claim 1, wherein the radially outer edge of the cover hood has radial slits, between which slits an outer edge region of the cover hood is configured in the form of elastically resilient sheet-metal tabs.

3. The piston according to claim 2, wherein a length of the slits in the edge the centrally located opening and the slits in the edge of the cover hood corresponds at least approximately to one-fifth of a distance between the radially outer edge of the cover hood and the edge of the opening.

4. The piston according to claim 2, wherein the slits in the edge the opening are radially offset from the slits in the radially outer edge of the cover hood.

5. The piston according to claim 1, further comprising a formed-on part that is step-shaped in cross-section and directed radially outward, said formed-on part being disposed on a radial outside of the neck, at a distance from the bead, wherein the cover hood lies against the formed-on part under bias.

6. The piston according to claim 1, wherein the radially outer edge of the cover hood lies under a lower, inner weld bead in the region of the ceiling element, and lies against the weld bead.
